(19) United States
(12) Patent Application Publication
(10) Pub. No.: US 2010/0002898 A1
(43) Pub. Date: Jan. 7, 2010

(54) USER FRIENDLY PORTABLE STEREO SET

(75) Inventor: Joshua Murray, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/370,926

(22) Filed: Feb. 13, 2009

Related U.S. Application Data
(60) Provisional application No. 61/078,354, filed on Jul. 4, 2008.

(51) Int. Cl. H04Q 1/02

(52) U.S. Cl. 381/334

(57) ABSTRACT

The invention relates to a sound output device which comprises a first and a second sound element, where the first sound output element comprises a space which receives an electrical connection to the second sound output element and a protrusion which engages a recess in the second output element which thereby forms a fastening connection. The first and second output units can be connected to form an integral unit where the integral unit can receive an electrical cord which can be wound around the fastening connection.

### TECHNICAL FIELD

The present invention relates to the field of portable speakers and, in particularly, to portable stereo speakers for mobile communication devices.

### BACKGROUND

In recent years the sound quality produced when playing back music and sound in mobile communication devices has improved dramatically. Recent mobile communication devices offer essentially the same quality and functionality present in a stand-alone portable music player, such as an MP3-player.

The implementation of more advanced sound playback circuits in mobile communication devices has also impacted the development of portable loudspeakers which can be connected to the mobile communication device. In this fashion, a user of the mobile communication device may enjoy music or sound output in a similar fashion as from stereo equipment.
Such portable loudspeakers have to fulfill a number of criteria of which the most important are portability, small size, light weight, ease of use, and good sound quality. While these problems have been solved in different ways by portable loudspeakers of known technology there is still a need to make an easier solution which protects the loudspeakers during transport and at the same time reduce the packaging of the portable loudspeakers.
At the same time it would also be desirable to provide better and easier handling of the loudspeaker cord for connecting the portable loudspeakers when not in use. One other characteristic which may be desirable would be to provide a premium appearance of the portable loudspeakers to the end-user as an additional selling argument.

### SUMMARY OF THE INVENTION

With the above and following description in mind, then, an aspect of the present invention is to provide, which seeks to mitigate, alleviate, or eliminate one or more of the above-identified deficiencies in the art and disadvantages singly or in any combination.

An first aspect of the present invention relates to a sound output device comprising a first and a second sound output element where the first sound output element comprise a space for receiving an electrical connector to the second sound output element, a protrusion for engaging a recess in the second sound output element, thereby forming a fastening connection, the first and the second sound output elements being connectable such as to form an integral unit, the integral unit comprise a portion surrounding the fastening connection, the portion being adapted for receiving an electrical cord wherein the electrical cord is being woundable around the fastening connection.

The protrusions may be separable from the first sound output element.

The portion of the sound output device may also comprise a volume around the fastening connection for receiving the electrical cord.

The volume of the sound output device may also be an inner volume.

At least one of the first or second sound output elements in the sound output device may comprise a rigid and an elastic portion, the elastic portion being adapted for being deformed by the electrical cord when wound around the fastening connection.

The portion of the sound output device may also comprise at least a part of the elastic portion.

The portion of the sound output device may also comprise a groove, the electrical cord being woundable around the fastening connection through the groove.

The elastic portion of the sound output device may comprise an opening through which at least a part of the electrical cord can be unwound.

The integral unit of the sound output device may essentially be elongated in shape.

The integral unit of the sound output device may also comprise that the first and the second sound elements may be connected to each other at an angle.

The electrical cord may also comprise an electrical connector, the electrical connector being adapted to fit into said space, wherein said space is located within the portion surrounding the fastening connection.

The electrical cord may also comprise an electrical connector, the electrical connector adapted to fit into said space, wherein said space is located within a symmetrical protruding structure in the second sound output element.

A second aspect of the present invention relates to a sound output element comprising a protrusion for engaging a recess such as to form a fastening connection and a volume, the volume being adapted for receiving the electrical cord to be wound around the fastening connection.

The volume of the sound output element may also be an inner volume adapted for containing the electrical cord.

The sound output element may further comprise a support structure located essentially opposite a sound output unit, the support structure being arranged to allow the sound output element to rest on an essentially flat ground surface.

A third aspect of the present invention relates to a sound output element comprising a recess for engaging a protrusion such as to form a fastening connection and a volume, the volume being adapted for receiving an electrical cord to be wound around the fastening connection.

The volume of the sound output element may also be an inner volume adapted for containing the electrical cord.

The sound output element may further comprising a support structure located essentially opposite a sound output unit, the support structure being arranged to allow the sound output element to rest on an essentially flat ground surface.

Any of the features in the first, second, or third aspect of the present invention above may be combined in any way possible.

### BRIEF DESCRIPTION OF THE DRAWINGS

Further objects, features, and advantages of the present invention will appear from the following detailed description of some embodiments of the invention, wherein some embodiments of the invention will be described in more detail with reference to the accompanying drawings, in which:

FIG. 1 shows a mobile communication device, in this case a mobile phone, according to an embodiment of the present invention; and

FIG. 2 shows a pair of prior art loudspeakers for a mobile communication device; and

FIG. 3 shows two sound output elements fitted together into a single unit according to the present invention; and

FIG. 4 shows another configuration of how the two sound output elements may be fitted together into a single unit according to the present invention; and

FIG. 5 shows two sound output elements separated and in a listening position, placed on the table, according to the present invention; and

FIG. 6 shows the fastening means on the two sound output elements, according to the present invention; and

FIG. 7 shows fastening means, comprising movable magnets, on the two sound output elements, according to the present invention; and

FIG. 8 shows how the speaker contact may be placed or secured in the fastening means on the two sound output elements, according to the present invention; and

FIG. 9 shows fastening means, comprising protrusions, on the two sound output elements, according to the present invention.

### DETAILED DESCRIPTION

Embodiments of the present invention relate, in general, to the field of loudspeakers for mobile communication devices. A preferred embodiment relates to a portable stereo loudspeaker for mobile phones. However, it should be appreciated that the invention is as such equally applicable to electronic devices which do not include any radio communication capabilities. However, for the sake of clarity and simplicity, most embodiments outlined in this specification are related to mobile phones.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

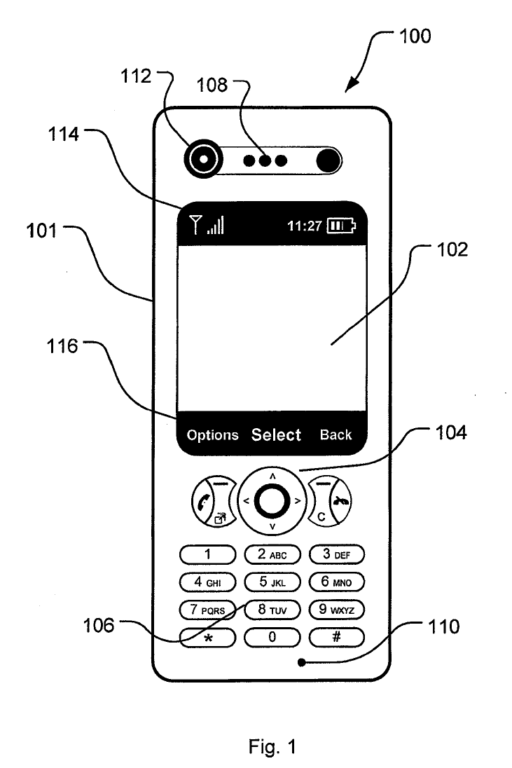

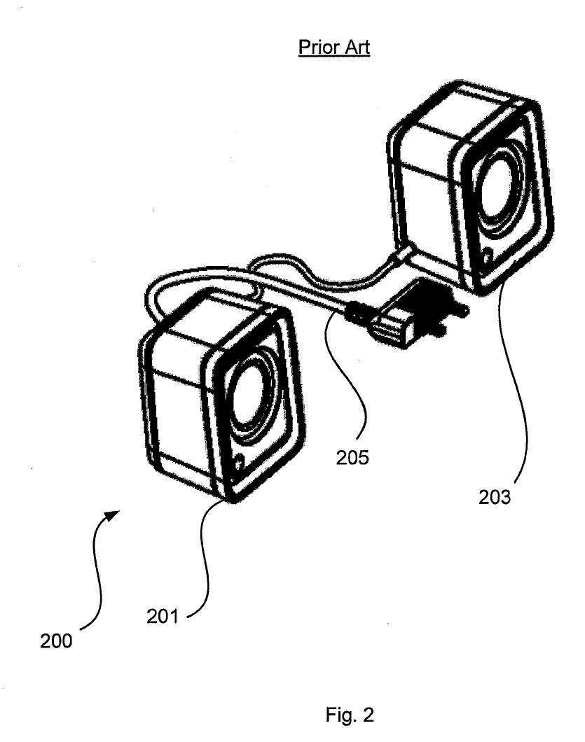

FIG. 1 show a mobile communication device 100 comprising a casing 101, a display area 102 and means 104 for navigating among items (not shown) displayed in the display area. The display area 102 may comprise a status indication area 114 and one or more softkey bars 116. The status indication area 114 may for example include symbols for indicating battery status, reception quality, loudspeaker on/off, present mode, time and date, etc. The status indication section is not in any way limited to include the symbols and the functions presented herein. The softkey bar 116 is operable using the navigation means 104 or, if using a touch sensitive screen, by tapping the softkey directly with a pen-like object, a finger, or other body part. The functions of the softkeys are not limited by the functions indicated in the figure. Neither are the placements of the softkey bar 116 and the status indication area 114 limited to be placed at the bottom and the top of the screen, as shown in the example. The navigation means 104 can be a set of buttons, a rotating input, a joystick, a touch pad, a multidirectional button, but can also be implemented using a touch sensitive display, wherein the displayed items directly can be tapped by a user for selection, or be voice activated via a headset or a built-in microphone. The mobile communication device 100 can also comprise other elements normally present in such a device, such as a keypad 106, a internal speaker 108, a microphone 110, a camera 112, a processor (not shown), a memory (not shown), one or more accelerometers (not shown), a vibration device (not shown), an AM/FM radio transmitter and receiver (not shown), a digital audio broadcast transmitter and receiver (not shown), etc. Several types of accessories may be connected to the mobile communication device 100 such as for instance one or more external speakers or sound output elements as shown in FIG. 2.

FIG. 2 illustrates an ordinary pair of sound output elements 200, or loudspeakers. The electrical cord 205, supplying the individual sound output elements (or loudspeakers) 201, 203 with an audio signal to be converted into an audible sound in the sound output elements, is often bundled together or wired around the two sound output elements. This way of storing, and making the speakers portable, will in many cases result in a tangled mess comprising the electrical cord 205 and the two sound output elements 201, 203, which may be difficult and cumbersome to sort out when the sound output elements is going to be used, thus reducing the usability of the speaker system considerably. Also, when transporting the sound output elements it is in many cases necessary to package them in some kind of bulky transport container, which often gets misplaced, to protect the sound output elements from being damage.

One way of solving, or at least mitigate, the problems discussed above, is further described in the following embodiments of the present invention.

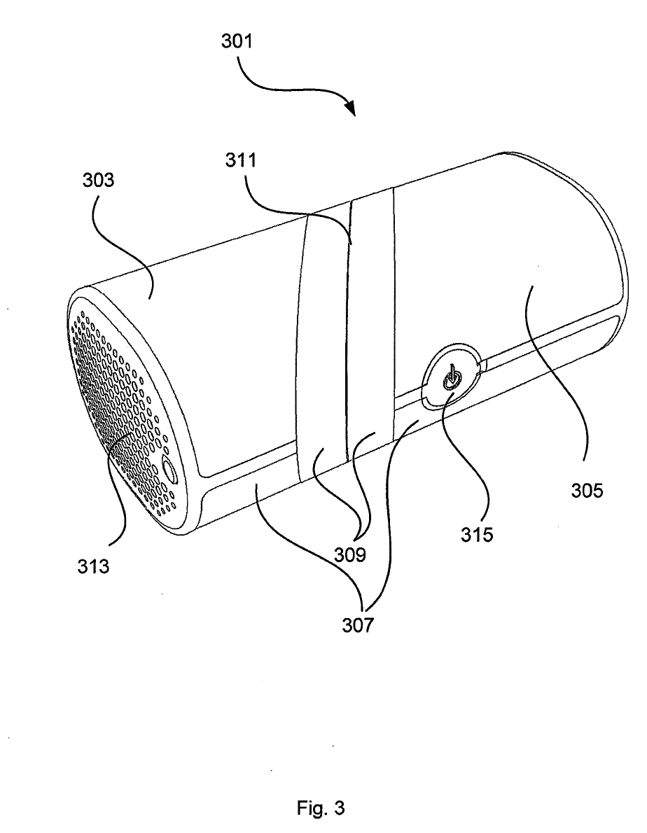

FIG. 3 shows an embodiment of the present invention where a loudspeaker system comprising of two sound output elements 303, 305 fastened together, forming a single integral unit 301 of an essentially elongated shape. The sound output elements 303, 305 comprise a rigid 307 and an elastic portion 309. In this embodiment the two elastic portions 309 faces each other forming an elastic portion with a slit 311. In this way the electric cord from the two sound output elements may be pressed down onto and through the elastic portion into the interior volume formed by the integral unit, which in this embodiment also has an internal cavity 615, 701, 801, 916, that the connector end of the cord is attached into for storage and transport. The rigid portion 307 may be made of metal, an alloy, plastic, wood, rubber, glass, or any combination thereof which produces a rigid or semi-rigid material. The elastic portion 309 may be made of silicon, rubber, plastic, metal, an alloy, or any combination thereof which produces an elastic material. In this embodiment the sound output units, or speaker elements, are placed on either end, behind a perforated piece 313, of the integral unit 301 as shown in the figure. In this way the sound output units 313 are protected from unintentional shocks and bumps and still are able to let audible sound pass through. The perforated piece 313 may be made of metal, an alloy, plastic, wood, rubber, glass, or any combination thereof which produces a rigid, semi-rigid material, or shock absorbent material. The elastic portion 309 may in one embodiment surround the integral unit 301, as shown in the figure, while in another embodiment only surround part of the integral unit. The surrounding elastic portion may either be located 90 degrees in relation to the rigid portion, or it may be located in a different angle, such as a 45 degree angle as shown in FIG. 3. In this embodiment a circular rubber cap, hiding a signal socket 315, is placed on the rigid portion 305 of the integral unit 301. In this way an external sound source, such as a mobile phone as in FIG. 1 or a audio receiver, may be connected, using for instance a 3.5 mm audio jack connector, to the integral unit making use of the sound output elements. The integral unit 301 may also take other shapes such as being in the form of a cube, triangle, quadratic, spherical, or an abstract shape. In another embodiment the signal socket 315 may not be present.

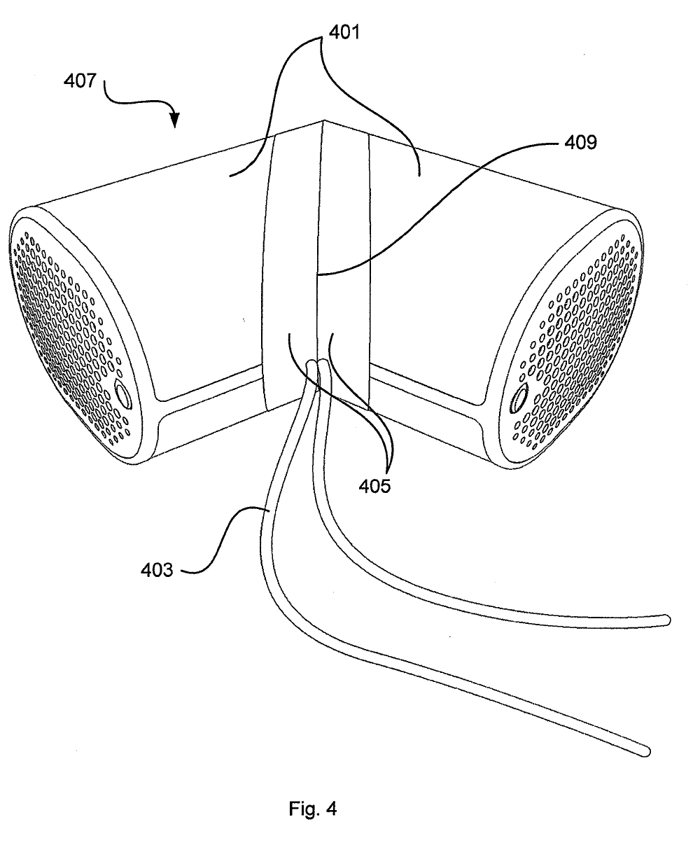

The two sound output elements 401 may also be fastened together in an angle. FIG. 4 shows an embodiment where the two sound output elements 401 are fastened together in 90 degree angle to each other. The different fastening position, as shown in FIG. 3 and FIG. 4, may give different advantages in the form of better acoustic properties/performance, or to rest more safely on the surface they are placed on. If a piece of the electrical cord 403 is pulled out through the elastic portion 405 via the slit 409 from within the integral unit 407, the integral unit may be hanged from this piece of cord. The two sound output elements 401 may not necessary be fastened together in a 90 degree angle. In other embodiments The two sound output elements 401 may be fastened together in another angle in space (x, y, z-planes).

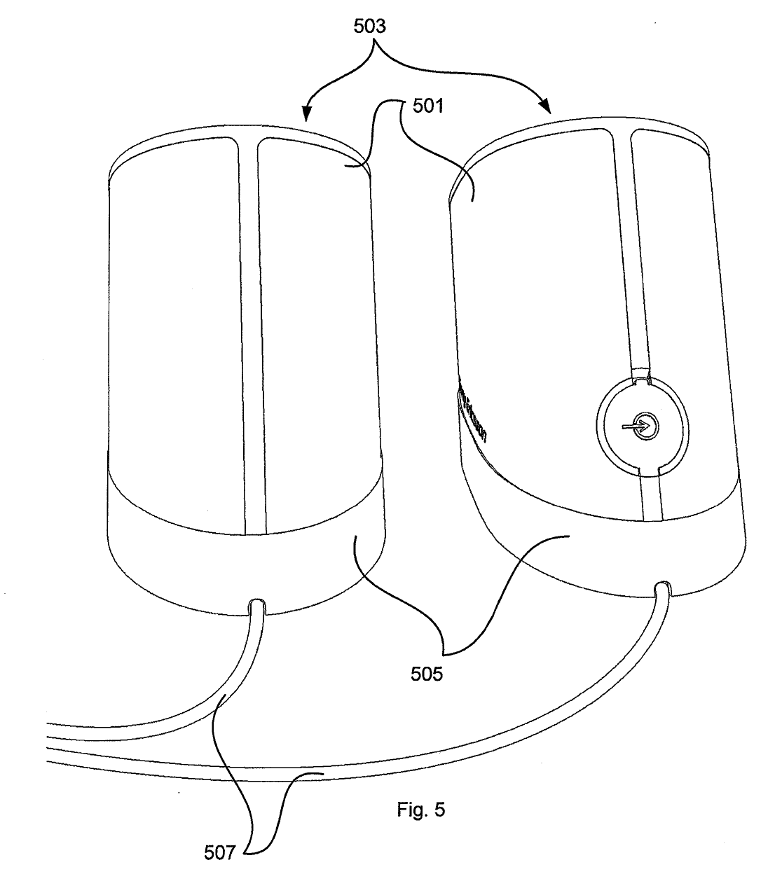

FIG. 5 shows another embodiment of the present invention where the two sound output elements 501 are separated from each other and placed, with the sound output units 503 facing up, on a surface. In one embodiment the sound output units 503 may face up into the air (away from the surface), and in another embodiment the sound output elements 503 face down (towards the surface), and in yet another embodiment the sound output elements may face any angle there in between. In yet another embodiment the sound output elements 501 are adjustable to face any angle and direction in comparison to the surface it is placed onto. In the embodiment shown in FIG. 5 the sound output elements rests on a portion of the elastic portions 505. One or more cuts may be made in the elastic portions so that the electrical cord 507 or cords may stick out from within the sound output elements 501 without affecting the resting stability of the sound output elements 501.

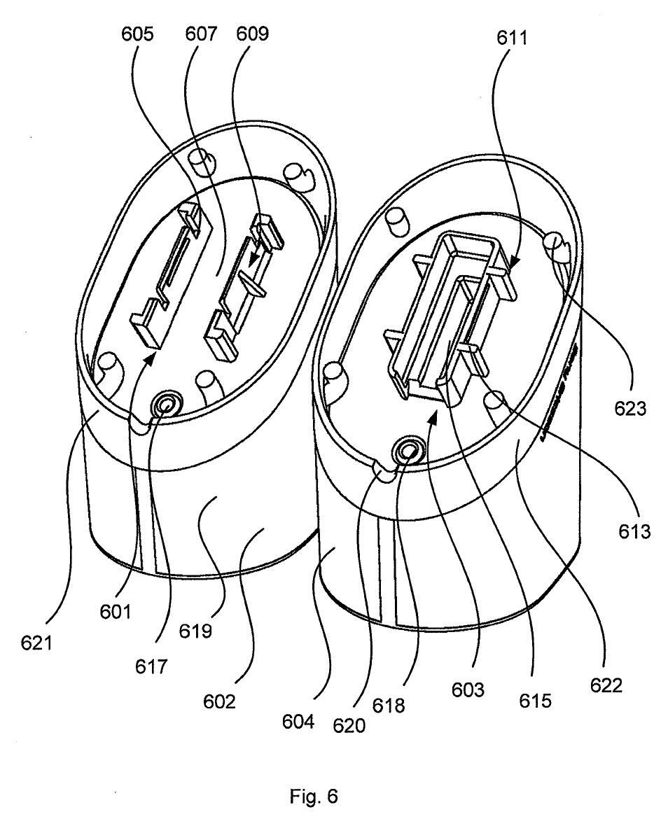

FIG. 6 shows the fastening means 601, 603 of the sound output elements 602, 604 according to an embodiment of the present invention. It can be seen from the figure that the fastening means 601, 603 are located on a side opposite the sound output units (not shown) or speaker elements. In the embodiment shown in FIG. 6, these fastening means 601, 603 comprise recesses 605 which are arranged as two recess pairs in a symmetrical structure 609 protruding from a ground surface 607 in the left sound output element 603. In the right sound output element 604 the fastening means 603 comprises corresponding protrusions 613 arranged in two protrusions pairs in a symmetrical protruding structure 611. Now the two sound output elements 602, 604 are connected together by placing the two sound output elements 602, 604 on top of each other and applying a downward force. This will result in a fastening of the speakers through the engaging of the protrusions 613 in the right sound output element 604 into the recesses 605 in the left sound output element 602. Also seen in FIG. 6 is that the protruding structure in the right sound output element 604 comprises a space 615 in the form of a step-shaped recess for connecting an electrical cord connector (not shown) which is electrically connecting the two sound output elements 602, 604 together. This space 615 may comprise a loudspeaker, connector which may have any shape, used when electrically connecting a pair of loudspeakers to each other. Moreover, the sound output elements 602, 604 comprise openings 617, 618 in the support surface 607 through which the electrical cord (not shown) connecting the two sound output elements 602, 604 may be drawn. Furthermore, the sound output elements comprise a rigid and an elastic portion 619 and 621, which in this embodiment have an ellipse like shaped circumference. Their circumference may however have any other shape, such as a circular, squared, rectangular, triangular or another shape. Both sound output elements 602, 604 additionally comprise a support structure comprising the elastic portion 621, 622 and legs 623 protruding from the elastic portion 621, 622. It may be mentioned here that the rigid portion 619 may be made of plastic, metal, wood or any other rigid material, while the elastic portion may be made of any type of elastic material, such as an elastic type of plastic, rubber, resin or materials with similar properties. The main task of the support structure is to enable the sound output elements 602, 604 to stand or rest, using the elastic portion 621 and the legs 623, on an essentially flat surface, such as a table, glass or any other flat surface. Additionally, the legs 623 may prevent the sound output elements 602, 604 from slipping on the surface. In another embodiment the cord coming from an opening 618 may pass through an opening 620 in the elastic portion 622 thus eliminating the need for the legs 623, and in yet another embodiment the elastic portion may be made of a rigid material.

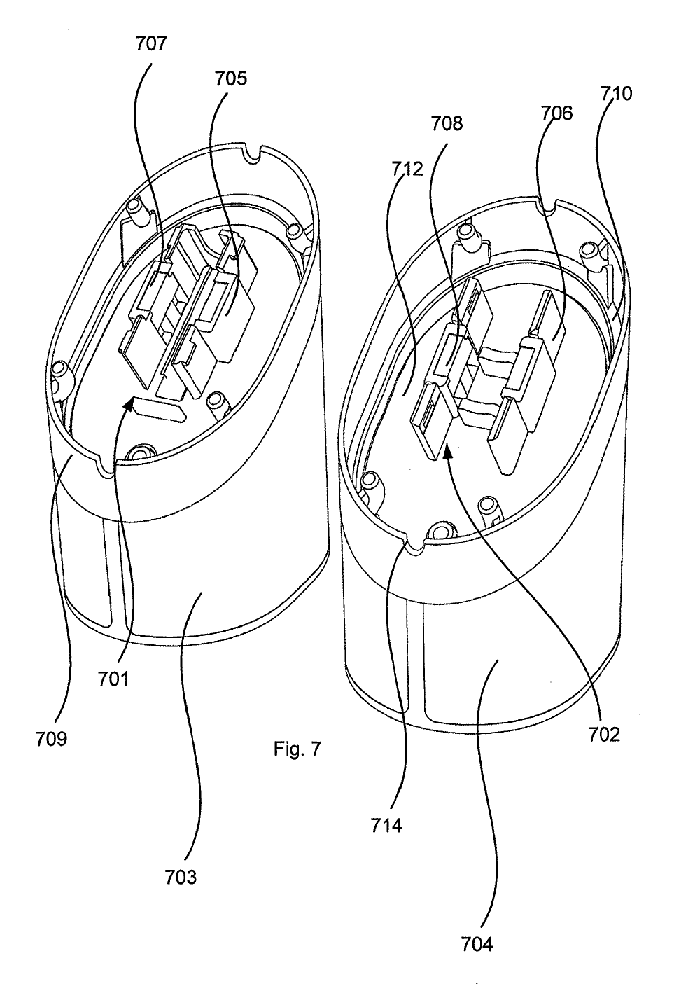

In FIG. 7, fastening means 701, 702 according to another embodiment of the present invention are illustrated. While very similar to the embodiment described in FIG. 6, the protruding structures 705, 706 in the left and right sound output elements 703, 704 corresponding to the protruding structures 609 and 611 in FIG. 6 additionally comprise a pair of recesses housing a pair of magnets 707, 708. The magnets 707, 708 bring the additional advantage of being able to prevent the accidental separation of the sound output elements 703, 704 when forming the single unit position as described in FIG. 3 due to for example a shearing or tearing force applied from the outside. In one embodiment the magnets 707, 708 may be fixed, an in another embodiment some of the magnets may be fixed while others may be movable, and in yet another embodiment all magnets may be movable. By movable we mean that the magnets may be able to move up a bit so that they protrude from their recesses, and back down into the recesses. Additionally, the sound output elements 703, 704 comprise an edge 710 rising somewhat from the support surface 712 described in FIG. 6. In this fashion, a larger volume for winding the electric cord connecting the two sound output elements 703, 704 is provided. This is especially practical, when the sound output elements 703, 704 are already connected together and the electrical cord is to be wound around the fastening connection. Also, the elastic portion 709 of the sound output elements 703, 704 may comprise an opening 714 through which the electric cord (not shown) connecting the two sound output elements 703, 704 may be unwound. The unwound portion of the electric cord may also be used as a transporting means for the sound output elements 703, 704 when connected into an integral unit according to FIG. 3.

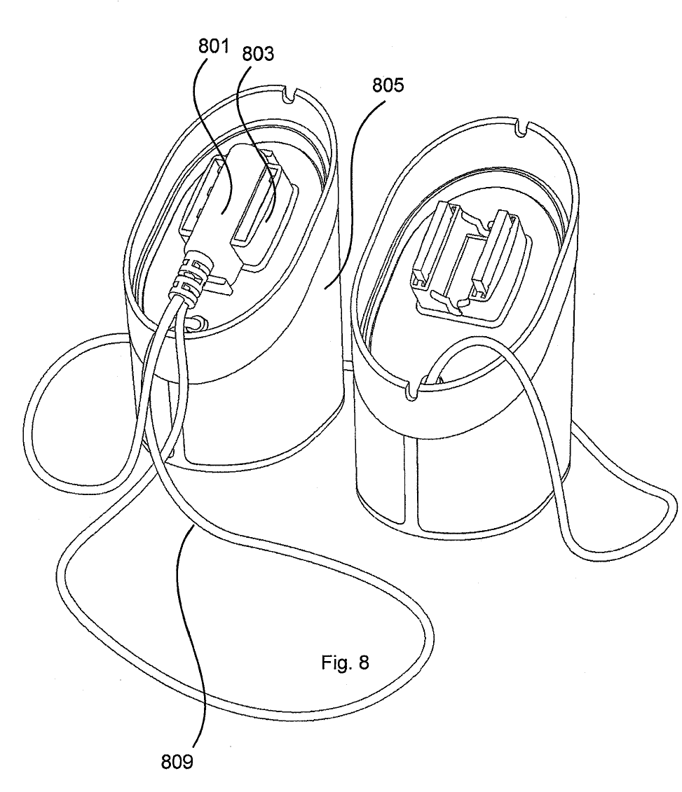

FIG. 8 illustrates how the speaker contact 801 may be placed in the fastening means 803 in the right sound output element 805. It may however be possible to arrange the speaker contact outside of the fastening means, if necessary. The main point is that there should be enough space around the fastening connection 803 for the electric cord 809 to be wound around the fastening connection 803 and inside the elastic portion when the two sound output elements 805,807 are connected into one unit.

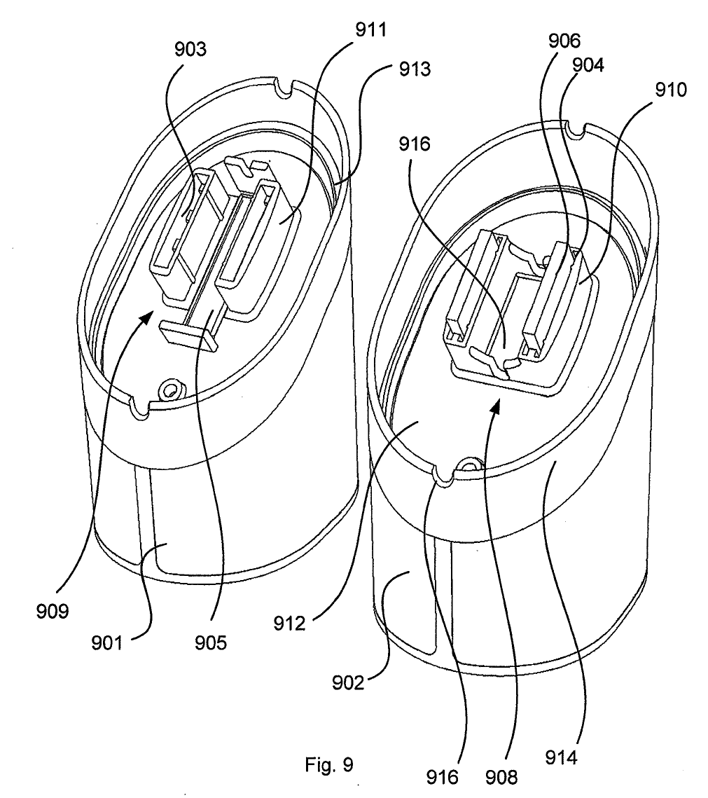

In FIG. 9, fastening means 908, 909 according to another embodiment of the present invention are illustrated. While very similar to the embodiments described in FIG. 6 and in FIG. 7, the protruding structures 911, 910 in the left and right sound output elements 901, 902, corresponding to the protruding structures 609 and 611 in FIG. 6 and to the protruding structures 705 and 706 in FIG. 7, additionally comprise a pair of pockets 903, 904. At least one, preferably two pockets 903, 904 (out of the total four pockets), may house a protruding part 906. The protruding part 906 may be made of a rigid material such plastic, metal, magnet, wood or any other rigid material, or of an elastic type of material such as plastic, rubber, resin or materials with similar properties. The shape of the protruding part 906 and the corresponding pocket 904 in the embodiment shown in FIG. 9 is rectangular. However, the shape of the protruding part 906 and the corresponding pocket 904 may also be circular, squared, triangular, star, elliptic, or any another type of shape. The protruding part 906 may either be separable from the pocket 904 or not. If more than one protruding part is used, the material of the additional protruding parts may be of the same material or of different materials. The two sound output elements 901, 902 are connected together by placing the two sound output elements on top of each other and applying a downward force. This will result in a fastening of the loudspeakers through the engaging of the protrusions 906 in the right sound output element 902 into the pockets 903 in the left sound output element 901.

In an embodiment the protruding part 906 is made of a magnetic material having a rectangular shape, as shown in FIG. 9. In this embodiment the pockets 904 in the right sound output elements 902 house protruding parts made of a magnetic material, while the bottom part of the pockets 903 in the left sound output elements 901 may house a material, such as iron, with magnetic properties. In this way the protruding magnetic material 906 will lock with the material having magnetic properties in the pockets 903 when connected forming the single unit position as described in FIG. 3. The magnets bring the additional advantage of being able to prevent the accidental separation of the sound output elements 901, 902.

In yet another embodiment the protruding part 906 may be movable from a drawn back position, where the protruding part 906 resides completely or partially inside the pocket 904, to a protruding position where a part of the protruding part 906 is protruding out of the pocket 904. When the two sound output elements 901, 902 are connected together the protruding part 906, in an embodiment, being made of a magnetic material may slide out from its pocket 904 and into the pocket 903 on the corresponding connecting sound output elements 901, locking with a magnetic material inside the corresponding pocket 903, and thus securely locking the two sound output elements 901, 902 firmly together.

Also, seen in FIG. 9, the protruding structures 910, 911 in the sound output elements 901, 902 comprise spaces 905, 916 for connecting an electrical cord connector (not shown in FIG. 9 but similar to the one shown in FIG. 8) which is electrically connecting the two sound output elements 901, 902 together. These spaces 905, 916 may house a loudspeaker connector, which may have any shape, used when electrically connecting the loudspeakers to each other and to the mobile phone.

Additionally, the sound output elements 901, 902 comprise an edge 913 rising somewhat from the support surface 912 described in FIG. 9. In this fashion, a larger volume for winding the electric cord connecting the two sound output elements 901, 902 is provided. This is especially practical, when the sound output elements are already connected together and the electrical cord is to be wound around the fastening connection. Also, the elastic portion 914 of the sound output elements may comprise an opening 916 through which the electric cord (not shown) connecting the two sound output elements 901, 902 may be unwound. The unwound portion of the electric cord may also be used as a transporting means for the sound output elements when connected into an integral unit according to FIG. 3.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. Sound output device comprising:
a first and a second sound output element;
the first sound output element comprising:
a space for receiving an electrical connector to the second sound output element;
a protrusion for engaging a recess in the second sound output element, thereby forming a fastening connection, the first and the second sound output elements being connectable such as to form an integral unit;
said integral unit comprising a portion surrounding the fastening connection, the portion being adapted for receiving an electrical cord wherein the electrical cord is being woundable around the fastening connection.

2. The sound output device according to claim 1, wherein the protrusions are separable from the first sound output element.

3. The sound output device according to claim 1, wherein the portion comprises a volume around the fastening connection for receiving the electrical cord.

4. The sound output device according to claim 3, wherein the volume is an inner volume.

5. Sound output device according to claim 1, wherein at least one of the first or second sound output elements comprises a rigid and an elastic portion, the elastic portion being adapted for being deformed by the electrical cord when wound around the fastening connection.

6. Sound output device according to claim 1, wherein said portion surrounding the fastening connection comprises at least a part of the elastic portion.

7. Sound output device according to claim 1, wherein the portion surrounding the fastening connection comprises a groove, the electrical cord being woundable around the fastening connection through the groove.

8. Sound output device according to claim 1, wherein the elastic portion comprises an opening through which at least a part of the electrical cord can be unwound.

9. Sound output device according to claim 1, wherein the integral unit is essentially elongated in shape.

10. Sound output device according to claim 1, wherein the integral unit comprises the first and the second sound elements connected to each other at an angle.

11. Sound output device according to claim 1, wherein the electrical cord comprises an electrical connector, the electrical connector adapted to fit into said space, wherein said space is located within the portion surrounding the fastening connection.

12. Sound output device according to claim 1, wherein the electrical cord comprises an electrical connector, the electrical connector adapted to fit into said space, wherein said space is located within a symmetrical protruding structure in the second sound output element.

13. A sound output element comprising:
a protrusion for engaging a recess such as to form a fastening connection and a volume, the volume being adapted for receiving the electrical cord to be wound around the fastening connection.

14. A sound output element according to claim 13, wherein the volume is an inner volume adapted for containing the electrical cord.

15. A sound output element according to claim 13, further comprising a support structure located essentially opposite a sound output unit, the support structure being arranged to allow the sound output element to rest on an essentially flat ground surface.

16. A sound output element comprising a recess for engaging a protrusion such as to form a fastening connection and a volume, the volume being adapted for receiving an electrical cord to be wound around the fastening connection.

17. A sound output element according to claim 16, wherein the volume is an inner volume adapted for containing the electrical cord.

18. A sound output element according to claim 16, further comprising a support structure located essentially opposite a sound output unit, the support structure being arranged to allow the sound output element to rest on an essentially flat ground surface.
